(19) United States
(12) Patent Application Publication
(10) Pub. No.: US 2009/0190959 A1
(43) Pub. Date: Jul. 30, 2009

(54) DEVELOPER AND IMAGE FORMING APPARATUS

(75) Inventor: Seiji Kikushima, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/357,457

(22) Filed: Jan. 22, 2009

(30) Foreign Application Priority Data
Jan. 24, 2008 (JP) 2008-014106

(51) Int. Cl. G03G 15/08

(52) U.S. Cl. 399/252

(57) ABSTRACT

A developer including a toner containing the cylindrical toner particles obtained by melting toner raw materials including binder resins, pigments, and waxes, forming a fibrous intermediate from the melted toner raw materials and cutting the fibrous intermediate, wherein the cylindrical toner particles have a ratio (L/D) of the cylindrical length (L) to the cylindrical cross-sectional diameter (D) of 0.1 to 0.9.

### BACKGROUND OF THE INVENTION

1. Field of the Invention

The present invention relates to a developer and an image forming apparatus employing the same.

2. Description of the Related Art

In developing devices for use in image forming apparatuses in electrophotographic process such as copying machines, printers, facsimiles, and multifunctional processing machines in combination thereof, a toner image is formed, as a toner is supplied onto a photosensitive body drum carrying, on the surface, an electrostatic latent image formed, based on image data. An image forming apparatus equipped with such a developing device transfers the toner image formed on the photosensitive body drum onto a particular paper. The transferred toner image is then fixed on the paper under pressure and heat in a fixing device, leaving the image based on the image data on the paper. After transfer of the toner image to the paper, the toner still remaining on the surface of the photosensitive body drum is removed, for example, with a cleaning blade. The electric charge on the surface of the photosensitive body drum is removed the by irradiation of static-eliminating light in a static charge-eliminating device before the next image forming operation.

The toner used in the image forming apparatus may be, for example, a one-component developer only made of toner or a two-component developer containing a toner and a carrier. For example, pulverization toners produced by pulverization of a mixture of toner raw materials and polymerization toners produced by dispersion and polymerization for example of colorants, additives, and particular monomers in a medium such as water have been used as the toners. Recently, in addition to the toners above, for example, toners obtained by so-called spinning method including a spinning step of melting toner raw materials and extruding the melted toner raw material into fibrous intermediate and a cutting/pulverizing step of cutting the fibrous intermediate into cylindrical toner particles were proposed (see, e.g., Japanese Unexamined Patent Publication No. 2006-106235: literature D1 and Japanese Unexamined Patent Publication No. 2006-162934: literature D2).

The method of producing a toner by spinning allows reduction in size (reduction in diameter) of the toner particles and narrowing of size distribution of toner particles (particle diameter distribution) easily in the spinning step and is thus, effective in producing toner particles. It is because it is easy to reduce fluctuation in fiber diameter of the fibrous intermediate prepared in the spinning step and also because it is possible to cut the fibrous intermediate according to the shape of the intermediate, to particles having a length (cut length) in the fiber direction (drawing direction) slightly larger than the fiber diameter in the cutting/pulverizing step.

As a result, the toner obtained by spinning is uniform in the size of toner particles (narrow particle diameter distribution) and the surface properties of the toner particles uniform, and thus, the toner can give a high-quality image.

In addition, the method of producing a toner by spinning does not demand a classification step as essential step and is thus superior in productivity.

However, by the spinning method, the binder resin molecules easily orient themselves in the fiber direction (drawing direction) of the fibrous intermediate, because the toner raw material melt-blended in the spinning step (blend of toner raw materials) is processed to the favorable toner diameter, as it is drawn from the terminal of nozzles (die) at high speed (e.g., 30 to 150 m/s) and then immediately cooled rapidly. In addition, because the melted toner raw material is less fluidal in the area of the nozzle channel close to the side wall, it is likely more vulnerable to shear deformation in the area close to the side wall than in the central region. Thus, molecule orientation of the binder resin is more obvious in the region of the fibrous intermediate close to the surface than in the central region of the intermediate, and under the influence, the functional materials in the toner raw materials, such as pigments, waxes, and antistatic agents, are likely located more in the central region than in the region close to the surface of the fibrous intermediate. In other words, the fibrous intermediate becomes anisotropic easily.

Cutting of such an intermediate often resulted in production of toner particles containing the functional material located more on the cut surface than on the cylindrical peripheral surface. Such a toner, with the functional materials located less on the toner particle surface, particularly on the cylindrical peripheral surface, deteriorated easily in fixing efficiency and electrostatic properties.

For that reason, proposed was a toner, in which the softening point of the binder resin and the difference between the softening points of the binder resin and the toner are specified (see, e.g., Japanese Unexamined Patent Publication No. 2006-301269: literature D3). According to literature D3, a toner superior in fixing efficiency and durability was obtained. If the relationship above is satisfied, it is possible to keep the viscosity of the melted toner raw material sufficiently low and to spin the melted toner raw material steadily and reliably by processing the raw material at a temperature higher by 100° C. than the softening point of the binder resin.

Alternatively, a cylindrical toner having a rate (L/D) of the toner cylindrical length (L) to the cylindrical cross-sectional diameter (D) at 1.2 to 10.0 was proposed (see, e.g., Japanese Unexamined Patent Publication No. 2006-293160: literature D4). Literature D4 discloses that it was possible to obtain a toner more favorable both in transfer efficiency and cleaning efficiency than conventional pulverization toners and superior in image quality.

However, unfavorably by the methods described in literatures D3 and D4, it was not possible to control the anisotropy in distribution of the functional materials in the toner raw materials, which in turn lead to deterioration in fixing efficiency and electrostatic properties.

### SUMMARY OF THE INVENTION

An object of the present invention is to provide a developer containing a toner superior in fixing efficiency and electrostatic properties and an image forming apparatus employing the same.

An aspect of the present invention is a developer comprising a toner containing the cylindrical toner particles obtained by melting toner raw material including binder resins, pigments, and waxes, forming a fibrous intermediate from the melted toner raw materials and cutting the fibrous intermediate, wherein the cylindrical toner particles have a ratio (L/D) of the cylindrical length (L) to the cylindrical cross-sectional diameter (D) of 0.1 to 0.9.

another aspect of the present invention is an image forming apparatus, comprising an image carrier carrying an electrostatic latent image formed on the P2977US surface and a development roller placed at a position facing the image carrier that supports and conveys a developer toner on the surface and supplies the conveyed toner to the surface of the image carrier, wherein the developer comprising a toner containing the cylindrical toner particles obtained by melting toner raw material including binder resins, pigments, and waxes, forming a fibrous intermediate from the melted toner raw materials and cutting the fibrous intermediate, wherein the cylindrical toner particles have a ratio (L/D) of the cylindrical length (L) to the cylindrical cross-sectional diameter (D) of 0.1 to 0.9.

The object, characteristics, aspects, and advantages of the present invention will become more evident in the following detailed description and the drawings attached.

### BRIEF DESCRIPTION OF THE DRAWINGS

FIG. 1 is a schematic view illustrating an example of the configuration of the toner in the developer of the first embodiment of the present invention.

FIG. 2A is an expanded perspective view illustrating the shape of the cylindrical toner particle 13.

FIG. 2B is a schematic view showing the end face shape of the cylindrical toner particle 13.

FIG. 2C is a schematic view showing the cross-sectional shape of the cylindrical toner particle 13.

FIG. 3 is a schematic view illustrating the melt-blending and spinning steps in production of the cylindrical toner particles contained in the toner of the developer of the first embodiment of the present invention.

FIG. 4 is a schematic view illustrating the cutting step in production of the cylindrical toner particles contained in the toner of the developer of the first embodiment of the present invention.

FIG. 5 is a schematic view illustrating an image forming apparatus 100 in the region close the image forming unit.

FIG. 6 is a sectional view illustrating an example of the developing device 34 in an image forming apparatus 100.

FIG. 7 is a sectional view illustrating another example of the developing device 35 in the image forming apparatus 100.

### DETAILED DESCRIPTION OF THE PREFERRED EMBODIMENT

After intensive studies, the inventors have found that orientation of the binder resin resulted in preservation of the shrinkage stress in the fibrous intermediate formed from the melted toner raw materials and the cylindrical toner particles obtained by cutting the intermediate and that loss of the orientation of the binder resin by heating could lead to heat shrinkage of the fibrous intermediate and the cylindrical toner particles.

As for the cylindrical toner particle, the length of (cylindrical length) (L) of the cylindrical toner particle shrinks in the fiber direction, but the volume of the cylindrical toner particle remains the same before and after heat shrinkage, thus making the ratio (L/D) of the cylindrical length (L) to the cylindrical cross-sectional diameter (D), lower. The inventors have found from the tendency that decrease in the ratio (L/D) by heat shrinkage of the cylindrical toner particle, i.e., increase in cylindrical cross-sectional diameter (D), lead to increase in exposure ratio of the functional materials such as pigments, waxes, and antistatic agents localized more on the cut surface than on the cylindrical peripheral face, leading to decrease in anisotropy of the functional materials and improvement in fixing efficiency and electrostatic properties.

The inventors have found that it was possible to induce heat shrinkage of cylindrical toner particles and thus to improve the fixing efficiency and electrostatic properties, by making the most of the binder resin's property of self orientation.

As a result, they have found a developer containing a toner superior in fixing efficiency and electrostatic properties and an image forming apparatus employing the developer.

Hereinafter, favorable embodiments of the present invention will be described specifically with reference to drawings. However, it should be understood that the present invention is not restricted by the embodiments at all.

### First Embodiment

The developer in the first embodiment of the present invention a developer including a toner containing the cylindrical toner particles obtained by melting toner raw materials including binder resins, pigments, and waxes, forming a fibrous intermediate from the melted toner raw materials and cutting the fibrous intermediate, wherein the cylindrical toner particles have a ratio (L/D) of the cylindrical length (L) to the cylindrical cross-sectional diameter (D) of 0.1 to 0.9.

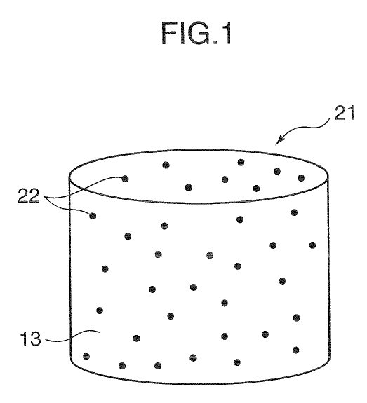

The toner is not particularly limited if it contains the cylindrical toner particles, and, for example, may be a toner obtained by adding an external additive 22 to cylindrical toner particles 13, as shown in FIG. 1. FIG. 1 a schematic view illustrating an example of the configuration of the toner contained in the developer of the first embodiment of the present invention.

### [Shape of Cylindrical Toner Particle]

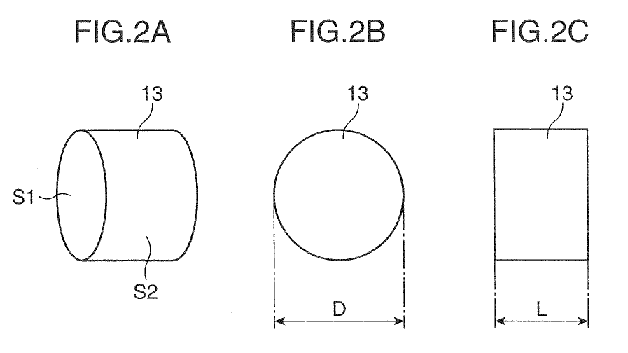

Hereinafter, the shape of the cylindrical toner particle 13 will be described with reference to FIGS. 2A, 2B and 2C. FIGS. 2A, 2B and 2C are schematic views showing the shape of the cylindrical toner particle 13; FIG. 2A is an expanded perspective view; FIG. 2B is an end face (cut face) view; and FIG. 2C is a side view. Cylindrical toner particles having a cylindrical length (L) and a cylindrical cross-sectional diameter (D) in the shape shown in FIG. 2 are obtained by spinning. Although a smooth cylinder is shown as the shape of the cylindrical toner particle in the present embodiment, there may be some deformation present in the end or peripheral shape, depending on production method, but the cylindrical toner particle according to the present invention, includes such cylindrical particles having such deformation.

As described above, the cylindrical toner particles 13 have a ratio (L/D) of the cylindrical length (L) to the cylindrical cross-sectional diameter (D) of 0.1 to 0.9, preferably 0.2 to 0.9, and more preferably 0.2 to 0.5. A ratio (L/D) of less than 0.1 leads to easier aggregation of the cylindrical toner particles, which in turn leads to deterioration in fluidity and also to deterioration of the cleaning efficiency of the toner remaining on photosensitive body drum. On the other hand, a ratio (L/D) of more than 0.9 leads to deterioration of the heat shrinkage of the cylindrical toner particle and insufficient increase in cylindrical cross-sectional diameter (D), and thus, to insufficient increase in the exposure ratio of the functional materials described below such as pigments and waxes and insufficient decrease in anisotropy of the functional materials, which in turn makes it difficult to improve the fixing efficiency and the electrostatic properties sufficiently.

The cylindrical length (L), the cylindrical cross-sectional diameter (D) and the ratio (L/D) of the cylindrical toner particles 13 are preferably in the ranges above, but the cylindrical length (L) is preferably 1 to 7 μm, more preferably 1 to 6 μm. Alternatively, the cylindrical cross-sectional diameter (D) is preferably 2 to 10 μm, more preferably 3 to 9 μm.

The cylindrical length (L), the cylindrical cross-sectional diameter (D), and the ratio (L/D) of the cylindrical length (L) to the cylindrical cross-sectional diameter (D) are values determined in the following way: An electron micrograph of cylindrical toner particles is obtained at 2000 time magnification under a scanning electron microscope (SEM); 30 cylindrical toner particles are selected at random in the image obtained; the cylindrical length, the cylindrical cross-sectional diameter, and the ratio of the cylindrical length to the cylindrical cross-sectional diameter of each cylindrical toner particle are determined; and the averages thereof are calculated respectively as L, D, and L/D. When the cut surface is not perpendicular to the axis of the cylindrical toner (when the cut surface is tilted or curved), the cylindrical length is the shaft line length L of the axis.

The cylindrical length (L), the cylindrical cross-sectional diameter (D), and the ratio (L/D) of the cylindrical length (L) to the cylindrical cross-sectional diameter (D) can be adjusted by modifying the kinds and the blending amounts of the binder resin used as a toner raw material, production condition and others.

### [Toner Raw Materials]

Hereinafter, the composition of the toner raw materials will be described in detail.

### (Binder Resin)

The binder resin for use as a toner raw material is not particularly limited, if it is a resin used as a binder resin in conventional toners. The toner for the developer in the present embodiment makes the most of orientation of the binder resin, i.e., the phenomenon that the cylindrical toner particles having the shrinkage stress inside by orientation of the binder resin shrink by heating because the orientation of the binder resin is relieved by heating. For that reason, the binder resin for use in the present embodiment is preferably a binder resin easily oriented molecularly and higher in crystallinity. Typical examples thereof include thermoplastic resins including polyester resins, polystyrene resins, acrylic resins, styrene-acrylic resin copolymers, olefinic resins such as polyethylene resins and polypropylene resins, vinyl chloride resins, polyamide resins, polyurethane resins, polyvinylalcohol resins, vinylether resins, N-vinyl resins, and styrene-butadiene resins; thermosetting resins including epoxy resins such as bisphenol-A epoxy resins, hydrogenated bisphenol-A epoxy resins, novolak epoxy resins, polyalkyleneether epoxy resins, and cyclic aliphatic epoxy resins, and cyanate resins; and the like. Among them, polyester resins are preferable. The binder resins above may be used alone or in combination of two or more as the binder resin.

The polyester resin is preferably, for example, an aromatic linear resin such as polyethylene terephthalate, because it is superior in crystallinity. Resins obtained by polycondensation or copolycondensation of alcohol components and carboxylic acid components, which have crystallinity lower than that of aromatic linear resins, are preferable, form the points of fix intensity and offsetting region.

Typical examples of the alcohol components include aromatic diols such as ethylene oxide and propylene oxide derivatives of bisphenol A, and the like.

Examples of the carboxylic acid components include aromatic dicarboxylic acids such as terephthalic acid and isophthalic acid, and the like.

The melting point (Tm) of the binder resin is preferably 80 to 170° C., more preferably 85 to 160° C. An excessively low melting point may lead to easier fusion of the cylindrical toner particles obtained and thus, to deterioration in storage stability of the toner. On the other hand, an excessively high melting point may lead to deterioration in fixing efficiency of the toner.

Alternatively, the glass transition point (Tg) of the binder resin is preferably 50 to 75° C. An excessively low glass transition point of the binder resin may lead to easier fusion of the cylindrical toner particles obtained and thus to deterioration in storage stability of the toner. On the other hand, an excessively high glass transition point of the binder resin may lead to deterioration in fixing efficiency of the toner.

The glass transition point of the binder resin can be determined from the inflection point of specific heat, as obtained by using a differential scanning calorimeter (DSC). Specifically, the glass transition point is determined, for example, by using a differential scanning calorimeter DSC-6200 manufactured Seiko Instruments Inc. as the analyzer, and by placing 10 mg of a test sample in an aluminum pan, while using an vacant aluminum pan as reference, and performing measurement in a test temperature range of 25 to 200° C. at a programmed heating rate of 10° C./min, and calculating from the inflection point in the endothermic curve obtained.

However, if two or more binder resins are used in combination, it is possible to obtain a toner superior in storage stability and fixing efficiency, by using a binder resin having higher melting and glass transition points and a binder resin having lower points in combination so that the binder resin as a whole has a melting point and a glass transition point in the ranges above.

As described above, it is possible by using the binder resins in combination as properly selected to shrink the cylindrical toner particles under heat by making the most of orientation of the binder resin so that the ratio (L/D) of the cylindrical length (L) to the cylindrical cross-sectional diameter (D) becomes a desired value. The heat-shrunk cylindrical toner particle has a cylindrical cross-sectional diameter (D) larger than that before heat shrinkage, and thus, the exposure ratio of the functional materials localized on the cut surface becomes inevitably larger than that on the cylindrical peripheral face it is thus possible to reduce the anisotropy of the functional materials and obtain a toner superior in fixing efficiency and electrostatic properties by using such a binder resin as a toner raw material.

### <Functional Materials>

### (Pigments)

The pigment in the toner raw materials is not particularly limited, if it is a pigment used in traditional toners, and such pigments include organic and inorganic pigments.

Typical examples of the inorganic pigments include black pigments such as carbon black, acetylene black, lamp black, and aniline black; yellow pigments such as Chrome Yellow, Zinc Yellow, Cadmium Yellow, Iron Oxide Yellow, Mineral Fast Yellow, Nickel Titanium Yellow, Naples Yellow, Naphthols Yellow S, Hansa Yellow G, Hansa Yellow 10G, Benzidine Yellow G, Benzidine Yellow GR, Quinoline Yellow Lake, Permanent Yellow NCG, and Tartrazine Lake; orange pigments such as Chrome Orange, Molybdenum Orange, Permanent Orange GTR, Pyrazolone Orange, Vulcan Orange, and Indanthren Brilliant Orange GK; red pigments such as Bengala, Cadmium Red, Red Lead, Mercury Sulfide Cadmium, Permanent Red 4R, Lithol Red, Pyrazolone Red, Watchung Red calcium salt, Lake Red D, Brilliant Carmine 6B, Eosin Lake, Rhodamine Lake B, Alizarin Lake, and Brilliant Carmine 3B; purple pigments such as Manganese Purple, Fast Violet B, and Methyl Violet Lake; blue pigments such as Iron Blue, Cobalt Blue, Alkali Blue Lake, Victoria Blue Lake, Phthalocyanine Blue, nonmetal Phthalocyanine Blue, Phthalocyanine Blue partially chlorinated, Fast Sky Blue, and Indanthren Blue BC; green pigments such as Chromium Green, Chromium Oxide, Pigment Green B, Malachite Green Lake, and Final Yellow Green G; white pigments such as zinc white, titanium oxide, antimony white, and zinc sulfide; extender pigments such as barytes, barium carbonate, clay, silica, white carbon, talc, and alumina white; and the like.

Typical examples of the organic pigments include C.I. Pigment Yellow 14, C.I. Pigment Yellow 83, C.I. Pigment Yellow 180, C.I. Pigment Blue 27, C.I. Pigment Blue 15-3, C.I. Pigment Red 166, C.I. Pigment Red 238, C.I. Pigment Violet 19, C.I. Pigment Violet 23, C.I. Pigment Green 7 and the like.

The blending amount of the pigment is normally 1 to 50 parts by mass, preferably 1 to 20 parts by mass, with respect to 100 parts of the binder resin.

### (Waxes)

The wax used in the toner raw materials is not particularly limited, if it is a wax traditionally used in toner particles. Typical examples thereof include vegetable waxes such as carnauba wax, sugarcane wax and wood wax; animal waxes such as beeswax, insect wax, spermaceti wax, and wool wax; synthetic hydrocarbon-based waxes such as Fischer-Tropsch waxes (hereinafter, referred to as “FT” waxes) having ester groups on the side chains, polyethylene wax and polypropylene wax; and the like. It is possible to determine whether the wax has ester groups on the side chains by separating the wax from the toner particles and determining the ester value of the wax: (saponification value)-(acid value) of the wax.

The blending amount of the wax is normally 2 to 6 parts by mass, preferably 3 to 5 parts by mass, with respect to 100 parts by mass of the binder resin. An excessively low blending amount may lead to insufficient advantageous effect by addition of the wax, while an excessively high blending amount may lead to separation thereof from the toner particles.

### (Antistatic Agents)

The toner raw material may contain an antistatic agent. Any compound that controls the electric charge on the toner without deterioration in properties of the toner may be used as the antistatic agent, and such compounds are grossly divided into positively charged antistatic agents and negatively charged antistatic agents. It is possible to adjust the polarity of the toner by using such a positively or negatively charged antistatic agent.

Typical examples of the positively charged antistatic agent include azine compounds such as pyridazine, pyrimidine, pyrazine, ortho-oxazine, meta-oxazine, para-oxazine, ortho-thiazine, meta-thiazine, para-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; azine compound-based direct dyes such as Azine Fast Red FC, Azine Fast Red 12BK, Azine Violet BO, Azine Brown 3G, Azine Light Brown GR, Azine Dark Green BH/C, Azine Deep Black EW, and Azine Deep Black 3RL; nigrosine compounds such as nigrosine, nigrosine salts, and nigrosine derivatives; nigrosine compound-based acidic dyes such as nigrosine BK, nigrosine NB, and nigrosine Z; metal salts such as of naphthenic acid and higher fatty acids; alkoxylated amines; alkyl amides; quaternary ammonium salts such as benzylmethylhexyldecylammonium and decyltrimethylammonium chlorides; quaternary ammonium salt-containing resins or oligomers; carboxylate salt-containing resins or oligomers ; carboxylic acid group-containing resins or oligomers; and the like. Among them, quaternary ammonium salts are used favorably.

Typical examples of the negatively charged antistatic agents include organic metal complexes, chelate compounds and the like. Typical examples of the organic metal complexes include acetylacetone metal complexes, salicylic acid-based metal complexes, the salts thereof, and the like, and typical examples of the chelate compounds include aluminum acetylacetonate, iron (II) acetylacetonate, chromium 3,5-ditertiary-butylsalicylate and the like.

The blending amount of the antistatic agent, if added, is normally 0.5 to 8 parts by mass, preferably 1 to 5 parts, with respect to 100 parts by mass of the binder resin.

### (Magnetic Powder)

If the toner for the developer in the present embodiment is used as a magnetic mono-component developer, a magnetic powder may be added to the toner raw material.

Typical examples of the magnetic powders include ferromagnetic metals such as iron, cobalt and nickel and alloys or compounds containing these elements such as ferrite and magnetite; alloys containing no ferromagnetic element but become ferromagnetic by suitable heat treatment; chromium dioxide and the like.

The blending amount of the magnetic powder, if added, is preferably 50 to 100 parts by mass, with respect to 100 parts by mass of the binder resin.

### [Method of Producing Toners]

The toner may be cylindrical toner particles prepared, for example, by the method of producing cylindrical toner particles described below or may be the particles obtained by adding an external additive to cylindrical toner particles, as shown in FIG. 1.

First, a method of producing cylindrical toner particles will be described.

### <Method of Producing Cylindrical Toner Particles>

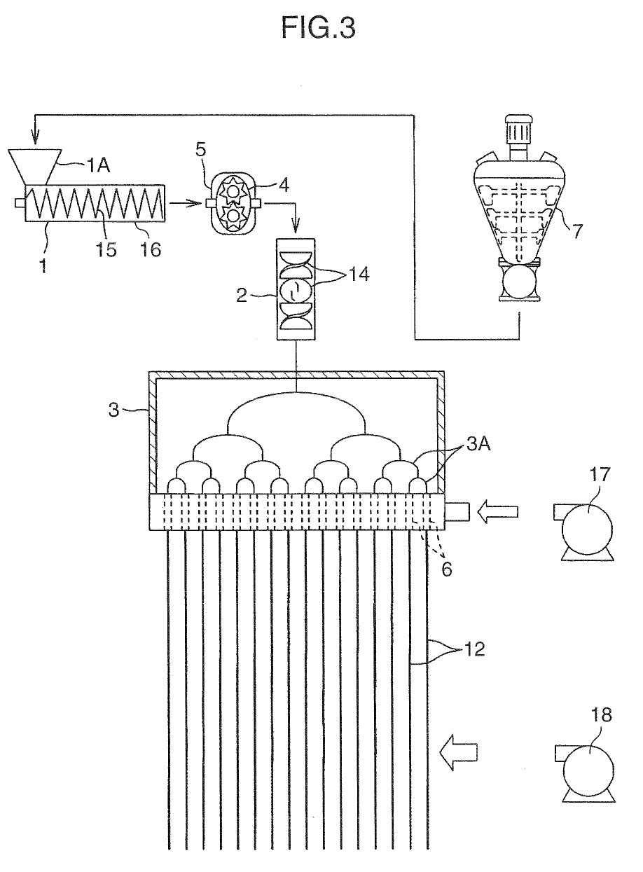

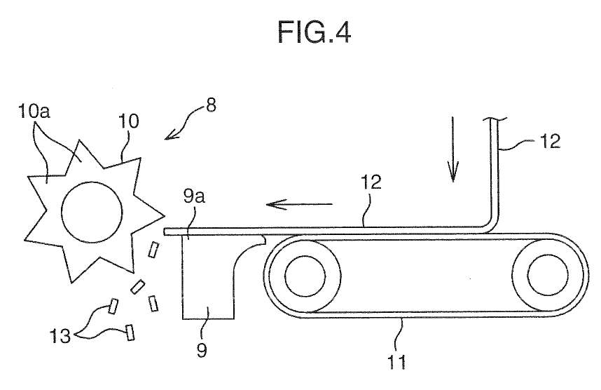

The method of producing cylindrical toner particles includes a melt-blending step of melting and blending toner raw materials, a spinning step of forming a fibrous intermediate with the melted toner raw material obtained in the melt-blending step, and a cutting step of cutting the fibrous intermediate into cylindrical toner particles. The method of producing cylindrical toner particles will be described in detail with reference to FIGS. 3 and 4. FIG. 3 is a schematic view illustrating the melt-blending and spinning steps in production of the cylindrical toner particles for the toner of the developer in the first embodiment of the present invention. Alternatively, FIG. 4 is a schematic view illustrating the cutting step in production of the cylindrical toner particles for the toner of the developer in the first embodiment of the present invention.

### (Melt-Blending and Spinning Steps)

First as shown in FIG. 3, toner raw materials are extruded in a molten state in an uniaxial extruder 1. Specifically, the toner raw materials are fed into a preliminary mixer 7 (e.g., Cyclomix, manufactured by Hosokawamicron Co., Ltd.) for mixing, and the mixture is withdrawn through a hopper 1A into an uniaxial extruder 1. The uniaxial extruder 1 has a cylinder 16 equipped with a heater not shown in the Figure and a revolving screw 15 for blinding the toner raw materials in the cylinder 16. The raw materials fed into the uniaxial extruder 1 are blended by the revolving screw 15. A gear pump 4 driven by a motor 5 is connected to the ejection nozzle of the uniaxial extruder 1 for adjustment of the discharge rate of the melted toner. The melted toner raw material is fed into a static mixer 2 connected to the gear pump 4. Examples of the extruders for extruding the toner raw material in a molten state include Henschel mixer manufactured by Mitsui Kosan, and the like.

The static mixer 2 contains multiple blades 14 in the twisted shape (3 pieces in FIG. 33) inside, and the blades 14 form a spiral channel. The melted toner raw material fed from the uniaxial extruder 1 is blended further with revolution of the blades 14, making the components of the toner raw material dispersed more uniformly and finely.

The static mixer 2 is connected to a channel structure 3 having multi-stage manifolds 3A. The melted toner raw material fed from the static mixer 2 to the manifold 3A is heated by a heater in channel structure 3 not shown in the Figure, extruded out of nozzles 6 at the terminals of the channels of the manifolds 3A into the fibrous shape, giving multiple fibrous intermediate filaments 12. The uniaxial extruder 1, the static mixer 2, the channel structure 3, and the gear pump 4 are respectively heated by heaters not shown in the Figure to a temperature higher than the melting point of the binder resin, for example, to around 130 to 240° C., to make the melted toner raw material less viscous.

The rate (spinning speed) of producing the fibrous intermediate 12 in the spinning step is preferably 90 m/s or more, more preferably 90 to 130 m/s. A spinning speed of 90 m/s or more makes orientation of the binder resin more distinctive, facilitating heat shrinkage of the cylindrical toner particle for example by heating and thus, allowing easier adjustment of the ratio (L/D) of the cylindrical length (L) to the cylindrical cross-sectional diameter (D) of the cylindrical toner particles to a desired value. For example, melt-blowing nozzles used for production of nonwoven fabrics may be used as the nozzles 6.

The diameter (fiber diameter) of the fibrous intermediate 12, which has influence on the cylindrical cross-sectional diameter (D) of the cylindrical toner particles, is preferably 3 to 8 μm.

In addition, the fibrous intermediate filaments 12 extruded out of respective nozzles 6 may be cut directly in the cutting step described below, but are preferably cooled and solidified and additionally drawn. Specifically, as shown in FIG. 3, the fibrous intermediate 12 extruded out of each nozzle 6 is preferably cooled and solidified rapidly by a cold air supplied from a cold air-supplying apparatus 17 and then drawn while heated by the hot air supplied from a hot air-blowing apparatus 18. The fibrous intermediate 12 is then, preferably drawn to a draw ratio (length after drawing/length before drawing in the filament direction) of 1.5 to 2.

As described above, because cooling/solidification and drawing of the intermediate before the cutting step make orientation of the binder resin more distinctive, it is possible to induce heat shrinkage of the cylindrical toner particles by heating and adjust the ratio (L/D) of the cylindrical length (L) to the cylindrical cross-sectional diameter (D) of the cylindrical toner particles to a desired value more easily.

### (Cutting Step)

Hereinafter, the cutting step of cutting the fibrous intermediate 12 will be described. The fibrous intermediate 12 is conveyed by a conveyor to a filament-cutting apparatus 8, as shown in FIG. 4. Specifically, the fibrous intermediate 12 is laid on a conveying means of belt conveyor 11 and conveyed to a filament cutting apparatus 8 in the horizontal direction. The fibrous intermediate filaments 12 are cooled to room temperature during conveyance into almost linear filaments having a favorable viscosity and conveyed in the horizontal direction, as aligned orderly. The conveyor for use may be an air-stream conveying means using air flowing at a particular flow rate in a flow direction, instead of the belt conveyor 11.

The filament cutting apparatus 8 has a fixed blade 9 extending in the direction perpendicular to the direction of the fibrous intermediate filaments 12 conveyed on the belt conveyor 11 and revolving blades 10 driven by a motor not shown in the Figure. The fibrous intermediate filaments 12 are supplied to the place between the fixed blade 9 and the revolving blades 10. The fibrous intermediate filaments 12 are cut continuously by the shearing force applied between the edge 9a of fixed blade 9 and the cutoff blades 10a of revolving blades 10, giving cylindrical toner particles 13.

The length (L) of the cylindrical toner particles 13 can be adjusted by modifying the ratio of the traveling speed of fibrous intermediate 12 to the rotational velocity of revolving blade 10. Alternatively, the cross section diameter (D) of the cylindrical toner particles 13 can be adjusted by modifying the internal diameter of the ejection nozzle openings of nozzle 6. The method of producing cylindrical toner particles including the melt-blending step and the spinning step will be called spinning method.

### (External Addition Step)

As described above, the toner may be cylindrical toner particles, or may be a mixture of the cylindrical toner particles with external additives, as shown in FIG. 1. Thus if the toner is a mixture of cylindrical toner particles and external additives, the cylindrical toner particles are treated in an external addition step.

The external addition step is not particularly limited, if it is a known external addition step. Specifically, it is, for example, a step of adding an external additive to the cylindrical toner particles, mixing them for example with a stirrer, and thus, depositing the external additive on the surface of the cylindrical toner particles.

The external additive for use is not particularly limited, if it is a known external additive, and typical examples thereof include inorganic oxides such as silica, titanium oxide and alumina; metal soaps such as calcium stearate; and the like. The blending amount of the external additive is preferably 0.3 to 4 parts by mass, with respect to 100 parts by mass of the cylindrical toner particles.

The stirrer is not particularly limited, if it is a known stirrer, and may be, for example, a common stirrer such as turbine stirrer, Henschel mixer, or super mixer.

The external addition step normally includes a heat-treating step of heating the mixture after addition of the external additive to the cylindrical toner particles. The heat-treating step may be carried out before, during or after stirring, for example, with a stirrer. If the melting point of the toner raw material binder resin is designated as Tm, the heat treatment temperature is preferably (Tm-50) to (Tm-20)° C., more preferably (Tm-40) to (Tm-20)° C. An excessively low heat treatment temperature may lead to insufficient heating of the cylindrical toner particles, prohibiting molecular movement of the binder resin for relaxation of the intramolecular distortion and thus, resulting in insufficient heat shrinkage of the toner. As a result, the cylindrical cross-sectional diameter (D) is not expanded sufficiently, leading to insufficient increase in exposure ratio of the functional materials such as pigments and waxes and insufficient reduction of the anisotropy of the functional materials. Thus, it may also make it difficult to improve the fixing efficiency and the electrostatic properties. On the other hand, an excessively high heat treatment temperature may lead to fusion of the cylindrical toner particles and mutual aggregation of the cylindrical toner particles, prohibiting preservation of the particle state.

In this way as described above, because heat treatment of the toner causes heat shrinkage of the cylindrical toner particles by orientation of the binder resin, it is possible to adjust the ratio (L/D) of the cylindrical length (L) to the cylindrical cross-sectional diameter (D) easily to 0.1 to 0.9. The toner thus obtained is lower in the anisotropy of the functional materials and thus, more superior in fixing efficiency and electrostatic properties.

In addition, the toner may be classified as needed after the heat-treating step. It is possible in this way to obtain a cylindrical toner narrower in particle size distribution.

### [Developer]

The developer in the present embodiment may be a one-component developer containing only the toner above or a two-component developer containing the toner and an additional carrier.

### <Magnetic Carrier>

If the toner for the developer in the present embodiment is used as the toner in a two-component developer, the toner is mixed with a carrier.

The carrier is not particularly limited, if it is a carrier traditionally used for developers. Typical examples thereof include magnetic material particles, resin particles containing a magnetic material in binder resin, and the like.

Typical examples of the magnetic materials include magnetic metals such as iron, nickel and cobalt, the alloys thereof, rare-earth metal-containing alloys, soft ferrites such as hematite, magnetite, manganese-zinc-based ferrite, nickel-zinc-based ferrite, manganese-magnesium-based ferrite and lithium-based ferrite, other iron-based oxides such as copper-zinc-based ferrites, the mixtures thereof, and the like.

Typical examples of the binder resins for use as the carrier include vinyl resins, polyester resins, epoxy resins, phenol resins, urea resins, polyurethane resins, polyimide resins, cellulosic resins, polyether resins, the mixture thereof and the like.

Magnetic material particles are produced by a known method such as sintering or atomization.

The carrier may have a cover layer of a coat resin on the surface.

The content of the carrier is not particularly limited, but, if the developer in the present embodiment is used as a two-component developer, it is preferably 700 to 2500 parts by mass, more preferably 1000 to 2000 parts by mass, with respect to 100 parts of the toner, from the point of the stability of the frictional electrostatic charge.

The developer in the present embodiment can be used in the image forming apparatus described below. Specifically, it may be used, for example, as a one-component developer or as a two-component developer, i.e., a mixture with the carrier at a suitable rate.

### [Image Forming Apparatus]

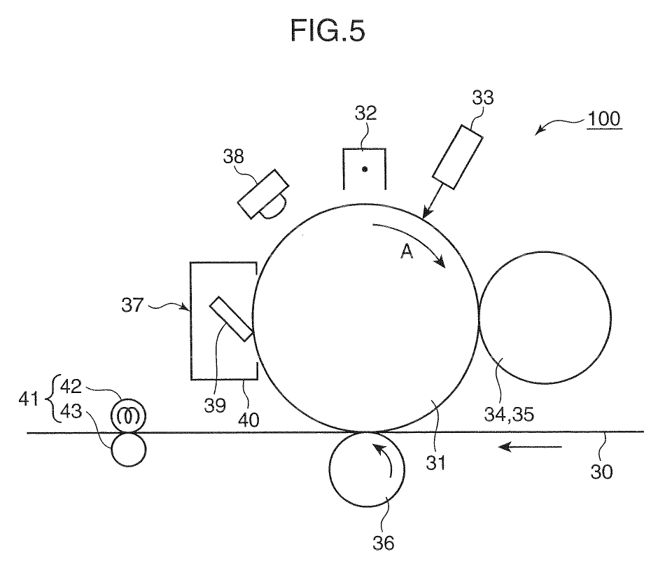

The image forming apparatus employing the developer in the present embodiment will be described. FIG. 5 is a schematic view illustrating the region close to the image forming unit of an image forming apparatus 100. The image forming apparatus 100 is an apparatus forming a particular image on a recording medium paper 30 by the electrophotographic process. As shown in FIG. 5, the image forming apparatus 100, has a charging device 32, an exposure device 33, a developing device 34 or 35, a transfer roller 36, a cleaner 37, a static charge-eliminating device 38 and others in that order in the revolving direction A of a photosensitive body drum 31 along the periphery of the photosensitive body drum 31. The positions of the cleaner 37 and the static charge-eliminating device 38 may be reversed.

The photosensitive body drum 31 for use is an amorphous silicon photosensitive body. A photosensitive body drum, i.e., a drum-shaped photosensitive body, is used as an example of the image carrier in the present embodiment, but the image carrier is not limited thereto, and other photosensitive body such as belt- or sheet-shaped photosensitive body may be used instead.

The charging device 32 is a device of electrifying the surface of the photosensitive body drum 31 to a particular electric potential by generating corona discharge. The exposure device 33 is a device of forming an electrostatic latent image on the surface of the photosensitive body drum 31 by selectively reducing the surface potential thereon by irradiation of light according to image data. The developing devices 34 and 35 are those of forming a toner image by developing the electrostatic latent image formed on the surface of the photosensitive body drum 31 with a toner, and specific examples thereof are the developing devices 34 and 35 described below. The transfer roller 36 is a device of transferring the toner image formed on the photosensitive body drum 31 onto the paper 30. The cleaner 37 has a rubber blade 39 for removal of the toner and others remaining on the surface of the photosensitive body drum 31 and a recovery container 40 for recovery of the toner and others removed by the rubber blade 39. The static charge-eliminating device 37 is a device diselectrifying the surface charge on the photosensitive body drum 31 by lamp light.

The image forming apparatus 100 has additionally a fixing device 41 (heating roller 42 and pressure roller 43) downstream in the paper 30-conveying direction. The fixing device 41 fixes the toner image by applying heat and pressure onto the toner image-transferred paper 30 and forms a particular image on the paper 30.

Hereinafter, the developing devices 34 and 35 used in the image forming apparatus 100 will be described separately.

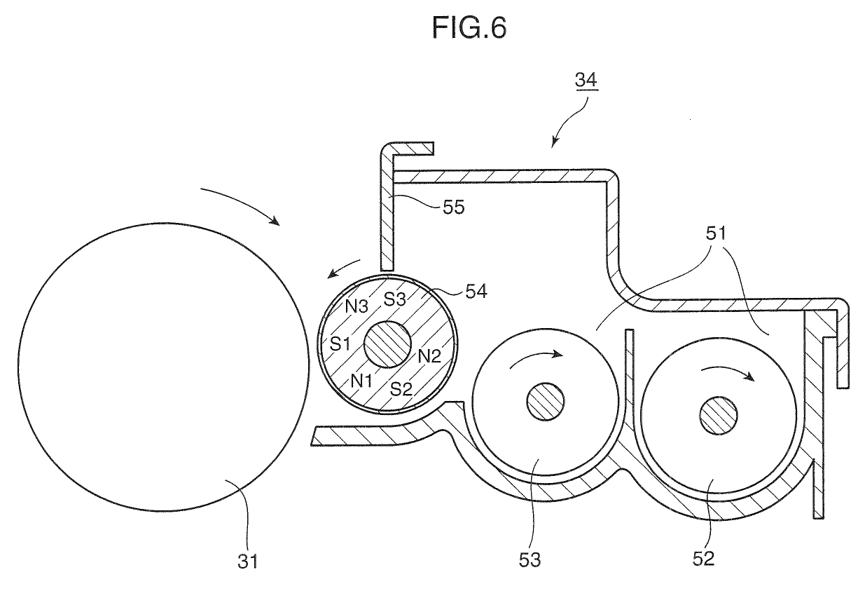

First, the developing device 34 will be described. FIG. 6 is a cross-sectional view illustrating an example of the developing device 34 installed in the image forming apparatus 100. The developing device 34 has a developer container 51 containing a two-component developer of toner and carrier not shown in the Figure, two agitating rollers 52 and 53 agitating the two-component developer, and a development roller 54 for supply of the toner to the surface of the photosensitive body drum 31. A blade 55 is installed at a position facing the development roller 54, and thus, it is a developing device in the two-component developing mode.

The agitating rollers 52 and 53 each have a spiral blade and electrify the two-component developer while agitating and conveying it in the mutually opposite directions. The agitating roller 53 supplies the charged two-component developer of toner and carrier to the development roller 54. The development roller 54 adsorbs and conveys the two-component developer with the magnets placed inside. The two-component developer is then brought into the shape of magnetic brush by the magnets in the development roller 54, and the thickness of the magnetic brush is controlled when the magnetic brush passes through the opening between the blade 55 and the development roller 54. The magnetic brush-shaped toner conveyed close to the photosensitive body drum 31 is transferred onto the photosensitive body drum 31 by the potential difference generated between the photosensitive body drum 31 and the development roller 54.

By the image forming operation, the developing device 34 develops an image, based on the electrostatic latent image formed on the photosensitive body drum 31.

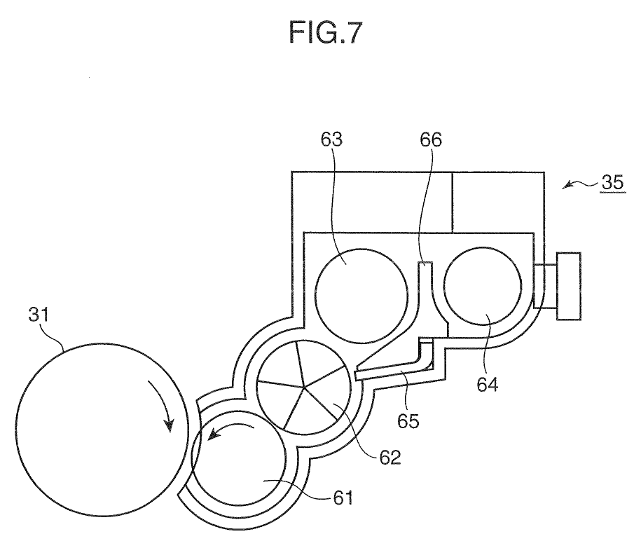

Hereinafter, the developing device 35 will be described. FIG. 7 is a cross-sectional view illustrating another example of the developing device 35 installed in the image forming apparatus 100.

The developing device 35 has, for example, a development roller 61, a magnetic roller 62, agitating rollers 63 and 64, a blade 65 and a partition plate 66.

The agitating rollers 63 and 64 each have a spiral blade and electrify the two-component developer while conveying and agitating it in the mutually opposite directions. The agitating roller 63 supplies the charged two-component developer of toner and carrier to the magnetic roller 62.

The magnetic roller 62 conveys the two-component developer, while absorbing the two-component developer with the magnets therein. The two-component developer is then brought into the shape of magnetic brush by the magnets in the development roller 62, and the thickness of the magnetic brush is controlled when the magnetic brush passes through the opening between the blade 65 and the development roller 62. The toner of the two-component developer conveyed close to the development roller 61 is transferred to the development roller 61, by the potential difference generated between the development roller 61 and the magnetic roller 62.

The development roller 61 supports and conveys the toner transferred from the magnetic roller 62 on the surface. And the toner conveyed close to the photosensitive body drum 31 is transferred to the photosensitive body drum 31 by the potential difference generated between the photosensitive body drum 31 and the development roller 61.

By the image forming operations above, the developing device 35 develops an image, based on the electrostatic latent image formed on the photosensitive body drum 31. In the developing device 34 or 35, the carrier, which is not consumed by development and remains therein, is recovered in the device and used as it is mixed again with the toner.

The image forming apparatus above is an apparatus transferring a toner image directly on paper, but the image forming apparatus according to the present invention is not limited thereto. For example, it may be a so-called tandem image forming apparatus of transferring toner images in multiple colors on an intermediate transfer belt and retransferring the toner images in multiple colors transferred on the intermediate transfer belt. The tandem image forming apparatuses are superior in image forming speed, but had a disadvantage that multiple image forming units including a photosensitive body drum and a developing device should be installed and the apparatus should be increased in size. A small tandem image forming apparatus having small-sized image forming units packed densely with narrow gap around a photosensitive body drum was proposed to solve the problems above. In such a small tandem image forming apparatus, the developing device is advantageously designed vertically, to minimize the size of the image forming unit in the width direction. It is thus desirable to place the developing device in the upward direction of the photosensitive body drum.

A developing device in the non-contact development system in which there is an opening between the photosensitive body drum and the development roller so that the magnetic brush does not brought into contact with the photosensitive body drum is preferable as the developing device applicable to such a small tandem image forming apparatus, because there is no deposition of the carrier on the photosensitive body and no scraping on the photosensitive body by the magnetic brush, thus allowing further improvement in image quality. For that reason, the developing device for application to the small tandem image forming apparatus is preferably not a two-component developing device 34 such as that shown in FIG. 6 in which the toner is provided from the development roller-shaped magnetic brush, but a developing device 35 such as that shown in FIG. 7.

As described above, the developer in the present embodiment, which has a ratio (L/D) of the cylindrical length (L) to the cylindrical cross-sectional diameter (D) of the cylindrical toner particles contained in the toner of 0.1 to 0.9, can reduce the anisotropy of the functional materials such as pigments and waxes.

Such a developer has favorable fixing efficiency and electrostatic properties.

Further, the toner for the developer in the present embodiment, which is produced by spinning method, allows improvement both in preservation of high image quality and in productivity.

### EXAMPLE

Hereinafter, the present invention will be described specifically with reference to Examples. However, it should be understood that the present invention is not restricted at all by these Examples. In the description below, “%” means “mass %”, and “parts”, “parts by mass”, unless specified otherwise,

### [Preparation of External Additive]

### <Titania A>

Titania particles (“Titania CR-EL,” manufactured by Ishihara Sangyo Kaisha, Ltd.) were placed in a Henschel Mixer; isopropyltriisostearoyl titanate was added to and mixed with it at 130° C. for coupling reaction; and the resulting resin was dried and pulverized to give titania A. Isopropyltriisostearoyl titanate was added in an amount of 3% with respect to the titania particles.

### <Silica A>

100 g of dimethylpolysiloxane (manufactured by Shin-Etsu Chemical), and 100 g of 3-aminopropyltrimethoxysilane (manufactured by Shin-Etsu Chemical) were dissolved in 200 g of toluene, and the mixture was diluted 10 times, to give a dilute solution. Then, the dilute solution obtained was added dropwise to 200 g of silica (“fumed silica Aerosil #90”, manufactured by Nippon Aerosil Co., Ltd.) while the mixture was agitated, and the resulting mixture was agitated for 30 minutes under ultrasonic irradiation. The mixture was heated in a high-temperature tank at 150° C.; toluene was removed by using a rotary evaporator; and the solid matter obtained was dried in a reduced-pressure drier at a set temperature of 50° C. until there was no decrease in weight. The solid was heated additionally in an electric furnace at 200° C. under a nitrogen stream for 3 hours. The powder obtained was pulverized in a jet mill and collected with a bug filter, to give silica A having an average diameter of 0.020 μm.

### [Preparation of Toners]

### <Toner A>

35 parts of a polyester resin A (melting point 92.4° C., glass transition point: 52.5° C.) and 65 parts of a polyester resin C (melting point: 142.0° C., glass transition point: 73.2° C.) as binder resins, 6 parts of a cyan pigment (C.I. Pigment Blue 15-3) as pigment, 5 parts of carnauba wax No. 1 powder ((manufactured by S. Kato & Co.) as wax and 1 part of a quaternary ammonium salt compound (“P-51,” manufactured by Orient Chemical Industries) as antistatic agent were mixed in a Henschel Mixer (manufactured by Mitsui Mining Com.), and the mixture was melt-blended in a biaxial extruder, to give a toner blend. The toner blend obtained was heated to a die discharge temperature at 200° C. and extruded through nozzles (φ100 μm) at a spinning speed of 111 m/s, to give a fibrous intermediate having a fiber diameter of 5.88 μm. The fibrous intermediate obtained was pulverized in a mechanical mill into cylindrical toner particles.

Then, 2 kg of the cylindrical toner particles obtained was placed in a Henschel Mixer; 30 g of titania A and 50 g of silica A were added thereto; the mixture was agitated at an agitating speed of 30 m/s for 3 minutes and then heat-treated at 95° C. for 10 minutes, to give a toner A. The cylindrical toner particles contained in the toner A obtained had a cylindrical cross-sectional diameter (D) of 6.53 μm and a cylindrical length (L) of 1.96 μm.

### <Toner B>

A toner B was prepared in a similar manner to the toner A, except that 50 parts of the polyester resin A and 50 parts of the polyester resin C were used and the spinning speed was changed to 125 m/s and the heat treatment temperature to 85° C. The cylindrical toner particles contained in the toner B obtained had a cylindrical cross-sectional diameter (D) of 6.47 μm and a cylindrical length (L) of 1.75 μm.

### <Toner C>

A toner C was prepared in a similar manner to the toner A, except that the polyester resin A was replaced with 35 parts of a polyester resin B (melting point: 87.2° C., glass transition point: 48.6° C.). The cylindrical toner particles contained in the toner C obtained had a cylindrical cross-sectional diameter (D) of 6.58 μm and a cylindrical length (L) of 1.58 μm.

### <Toner D>

A toner D was prepared in a similar manner to the toner A, except that the polyester resin C was replaced with 65 parts of a polyester resin D (melting point: 155.4° C., glass transition point: 73.6° C.) and the spinning speed was changed to 95 m/s and the heat treatment temperature to 105° C. The cylindrical toner particles contained in the toner D obtained had a cylindrical cross-sectional diameter (D) of 6.77 μm and a cylindrical length (L) of 2.78 μm.

### <Toner E>

A toner E was prepared in a similar manner to the toner A, except that the die discharge temperature was changed to 190° C. and the spinning speed to 92 m/s. The cylindrical toner particles contained in the toner E obtained had a cylindrical cross-sectional diameter (D) of 6.44 μm and a cylindrical length (L) of 3.16 μm.

### <Toner F>

A toner F was prepared in a similar manner to the toner A, except that the polyester resins A and C were replaced with 100 parts of a polyester resin E (melting point: 127.4° C., glass transition point: 59.7° C.) and the spinning speed was changed to 106 m/s and the heat treatment temperature to 100° C. The cylindrical toner particles contained in the toner F obtained had a cylindrical cross-sectional diameter (D) of 6.62 μm and a cylindrical length (L) of 1.86 μm.

### <Toner G>

A toner G was prepared in a similar manner to the toner A, except that the heat treatment temperature was changed to 75° C. The cylindrical toner particles contained in the toner G obtained had a cylindrical cross-sectional diameter (D) of 6.51 μm and a cylindrical length (L) of 5.72 μm.

### <Toner H>

A toner H was prepared in a similar manner to the toner A, except that the die discharge temperature was changed to 180° C., the fibrous intermediate was cooled and solidified before it is pulverized in a mechanical mill and drawn at 85° C. in a drawing apparatus to a length in the fiber direction of 1.7 times larger after drawing. The cylindrical toner particles contained in the toner H obtained had a cylindrical cross-sectional diameter (D) of 6.45 μm and a cylindrical length (L) of 1.35 μm.

### <Toner I>

A toner I was prepared in a similar manner to the toner A, except that the heat treatment temperature was changed to 65° C. The cylindrical toner particles contained in the toner I obtained had a cylindrical cross-sectional diameter (D) of 6.49 μm and a cylindrical length (L) of 9.28 μm.

### <Toner J>

A toner J was prepared in a similar manner to the toner A, except that the heat treatment temperature was changed to 115° C. The toner particles contained in the toner J obtained are not cylindrical and had an average particle diameter of 11.13 μm.

### <Toner K>

A toner K was prepared in a similar manner to toner K, except that the spinning speed was changed to 88 m/s. The cylindrical toner particles contained in the toner K obtained had a cylindrical cross-sectional diameter (D) of 5.71 μm and a cylindrical length (L) of 7.25 μm.

### <Toner L>

A toner L was prepared in a similar manner to the toner A, except that the spinning speed was changed to 67 m/s. The cylindrical toner particles contained in the toner L obtained had a cylindrical cross-sectional diameter (D) of 4.98 μm and a cylindrical length (L) of 11.6 μm.

### <Toner M>

A toner M was prepared in a similar manner to the toner A, up to the toner blend. The toner blend obtained was cooled on a drum flaker, pulverized with a hammer mill into coarse particles and further with a turbo-mill into fine powder, and classified with an air classifier, to give toner particles.

Then, 2 kg of the toner particles was placed in a Henschel Mixer; 30 g of titania A and 50 g of silica A were added thereto; the mixture was agitated at an agitating speed of 30 m/s for 3 minutes and heat-treated at 95° C. for 10 minutes, to give a toner M. The toner particles contained in the toner M obtained are not cylindrical and had an average particle diameter of 6.45 μm.

The melting and glass transition points of the binder resins (polyester resins) in respective toners obtained, the melting point of the binder resins as a whole, the toner production condition, and others are summarized in Table 1. The melting and glass transition points of the binder resin were determined in the following manner:

### <Measurement of the Melting and Glass Transition Points of Binder Resin>

The melting point of the binder resin was determined by using a flow tester (“CFT-500D,” manufactured by Shimadzu Corp.).

The glass transition point of the binder resin was determined by using a differential scanning calorimeter (DSC) from the inflection point of specific heat. Specifically, the analyzer used was a differential scanning calorimeter DSC-6200 manufactured by Seiko Instruments Inc.; 10 mg of a test sample was placed in an aluminum pan; an vacant aluminum pan was used for reference; measurement was carried out in a measurement temperature range of 25 to 200° C. at a programmed heating rate of 10° C./min; and the glass transition point was determined from the inflection point in the endothermic curve.

TABLE 1

| | BINDER RESIN (POLYESTER RESIN) | | | | | | | |
|---|---|---|---|---|---|---|---|---|
| | | | GLASS | BLENDING | | | GLASS | BLENDING |
| | | MELTING | TRANSITION | AMOUNT | | MELTING | TRANSITION | AMOUNT |
| | | POINT | POINT | (PARTS | | POINT | POINT | (PARTS |
| TONER | RESIN | (° C.) | (° C.) | BY MASS) | RESIN | (° C.) | (° C.) | BY MASS) |
| A | A | 92.4 | 52.5 | 35 | C | 142.0 | 73.2 | 65 |
| B | A | 92.4 | 52.5 | 50 | C | 142.0 | 73.2 | 50 |
| C | B | 87.2 | 48.6 | 35 | C | 142.0 | 73.2 | 65 |
| D | A | 92.4 | 52.5 | 35 | D | 155.4 | 73.6 | 65 |
| E | A | 92.4 | 52.5 | 35 | C | 142.0 | 73.2 | 65 |
| F | E | 127.4 | 59.7 | 100 | — | — | — | — |
| G | A | 92.4 | 52.5 | 35 | C | 142.0 | 73.2 | 65 |
| H | A | 92.4 | 52.5 | 35 | C | 142.0 | 73.2 | 65 |
| I | A | 92.4 | 52.5 | 35 | C | 142.0 | 73.2 | 65 |
| J | A | 92.4 | 52.5 | 35 | C | 142.0 | 73.2 | 65 |
| K | A | 92.4 | 52.5 | 35 | C | 142.0 | 73.2 | 65 |
| L | A | 92.4 | 52.5 | 35 | C | 142.0 | 73.2 | 65 |
| M | A | 92.4 | 52.5 | 35 | C | 142.0 | 73.2 | 65 |

| | | PRODUCTION CONDITION | | | | |
|---|---|---|---|---|---|---|
| | | | DIE | | | |
| | MELTING | | DISCHARGE | HEAT TREATMENT | SPINNING | |
| | POINT | PRODUCTION | TEMPERATURE | TEMPERATURE | SPEED | DRAWING |
| TONER | (° C.) | PROCESS | (° C.) | (° C.) | (m/s) | TREATMENT |
| A | 124.6 | SPINNING | 200 | 95 | 111 | NO |
| B | 117.2 | SPINNING | 200 | 85 | 125 | NO |
| C | 122.8 | SPINNING | 200 | 95 | 115 | NO |
| D | 133.4 | SPINNING | 200 | 105 | 95 | NO |
| E | 124.6 | SPINNING | 190 | 95 | 92 | NO |
| F | 127.4 | SPINNING | 200 | 100 | 106 | NO |
| G | 124.6 | SPINNING | 200 | 75 | 111 | NO |
| H | 124.6 | SPINNING | 180 | 95 | 111 | YES |
| I | 124.6 | SPINNING | 200 | 65 | 111 | NO |
| J | 124.6 | SPINNING | 200 | 115 | 111 | NO |
| K | 124.6 | SPINNING | 200 | 95 | 88 | NO |
| L | 124.6 | SPINNING | 200 | 95 | 67 | NO |
| M | 124.6 | PULVERIZATION | — | — | — | — |

In addition, properties of the respective toners are determined in the following manners, and the results are summarized in Table 2.

### <Measurement of Toner Properties>

### (Measurement of L/D)

30 toner particles are randomly selected; the photograph of the surface of each toner particle was taken under field-emission scanning electron microscope (“JSM-7401F,” manufactured by JEOL); the cylindrical cross-sectional diameter (D) and the cylindrical length (L) were measured respectively; and the ratio (L/D) of the cylindrical length (L) to the cylindrical cross-sectional diameter (D) was calculated, and the average determined. If the toner particle is not cylindrical, the particle is indicated by “-” in Table 2.

The fiber diameter of the fibrous intermediate was measured similarly.

### (Evaluation of Cutting/Pulverizing Efficiency)

The particle diameter distributions (of volume- and number-based particle diameters) of the toner particles obtained were determined by using Coulter Multimizer III (Beckmann Coulter). The coefficient of variation (standard deviation of particle diameters divided by average of particle diameters) of particle diameter was calculated and evaluated according to the following evaluation criteria. Both variation coefficients of the volume-based particle diameter and the number-based particle diameter were calculated. ◯ and Δ are satisfactory.

◯: The variation coefficient of the volume-based particle diameter is 20% or less, and that of the number-based particle diameter is 25% or less.

Δ: The variation coefficient of the volume-based particle diameter is more than 20% and 25% or less, and that of the number-based particle diameter is more than 25% and 30% or less.

×: The variation coefficient of the volume-based particle diameter is more than 25% and that of the number-based particle diameter is more than 30%.

### (Measurement of Particle Diameter Distribution)

The average particle diameter D50 (manufactured by volume-based average particle diameter) of the toner particles obtained was determined by using Coulter Multimizer III (Beckmann Coulter).

The variation coefficient (standard deviation of average particle diameter divided by average particle diameter D50) thereof was determined, in a similar manner to the calculation method used in evaluation of the cutting/pulverizing efficiency above.

### Example 1

### <Production of Developer>

### (Preparation of Carrier)

0.6 kg of PFA fine particles (fine particles of tetrafluoroethylene-perfluoroalkyl vinylether copolymer), and a solution of 2.4 kg of an epoxy resin (“Epikote 1004,” manufactured by Japan epoxy resin) dissolved in 40 kg of toluene were added to and coated on 10 kg of a ferrite-based carrier having an average particle diameter of 50 μm (“F51-50,” manufactured by Powder Tech Corp.) in a fluidized-bed coating apparatus (“SFC-5,” manufactured by Freund Co., Ltd.) while hot air at 80° C. was introduced. The mixture was baked in a drier at 230° C. for 1 hour and cooled and pulverized, to give a carrier.

### (Preparation of Two-Component Developer)

30 g of the toner A and 300 g of the carrier were mixed in a ball mill uniformly for 30 minutes under agitation, to give a two-component developer.

### Examples 2 to 8 and Comparative Examples 1 to 5

Two-component developers were in a similar manner to Example 1, except that the toner shown in Table 2 was used.

### <Evaluation>

Each of the two-component developers of Examples 1 to 8 and Comparative Examples 1 to 5 was evaluated in the following tests. Evaluation results are summarized, with the properties of the toners used, in Table 2.

### (Evaluation of Image Density)

A two-component developer was used in the test machine of an image forming apparatus shown in FIG. 5 (color multifunctional processing machine “KM-C3232”, manufactured by Kyocera Mita Corp.), and 50,000 sheets were printed intermittently under a high-temperature low-humidity environment (temperature: 32.5° C., relative humidity: 20%, ISO: 0.2%) for evaluation of durability.

After the intermittent printing durability test (after durability test), the image density in the black painted image region of copied image was determined by using a spectrophotometer (“SpectroEye,” manufactured by Gretag Macbeth). A solid image haging an image density of 1.2 or more is satisfactory, and that of less than 1.2 unsatisfactory.

### (Evaluation of Image Density Irregularity)

After the intermittent printing durability test on 50,000 sheets in evaluation of the image density above, a gray pattern at a resolution of 600 dpi and a printing rate of 25% was printed on a A4-sized sheet. The image density of the copied images at an interval of 1 cm horizontally and vertically was determined by using a spectrophotometer, and the variation coefficient, i.e., standard deviation of image density divided by average, was calculated. A variation coefficient of 7% or less is satisfactory, while that of more than 7% unsatisfactory.

### (Evaluation of Background Soil)

A two-component developer was used in a test machine of an image forming apparatus shown in FIG. 5 (color multifunctional processing machine “KM-C3232,” manufactured by Kyocera Mita Corp.), and 50,000 sheets were printed intermittently under a condition of a temperature of 10.0° C. and a relative humidity of 20%, and an ISO of 0.2% for evaluation of printing durability.

After the intermittent printing durability test, the difference of the image density of the nonimage region in the sample image (corresponding to white paper) from that of the base paper was used as the background soil density. The image density was determined by using a spectrophotometer (“SpectroEye,” manufactured by Gretag Macbeth). A background soil density of 0.008 or less is satisfactory, while that of more than 0.008 unsatisfactory.

### (Evaluation of Electrostatic Charge)

33 g of a two-component developer was weighed in a sample bottle, and agitated on a tumbler shaker mixer (manufactured by Shinmaru Enterprises Corp.) for 1 minute or for 120 minutes.

The electrostatic charge of the two-component developer after agitating for 1 minute or for 120 minutes was determined by using a suction-type electrostatic charge analyzer (“q/m meter MODEL 210HS,” manufactured by Trek Japan) and a No. 635 mesh (opening: 20 μm).

TABLE 2

| | TONER PROPERTIES | | | | | | | | | |
|---|---|---|---|---|---|---|---|---|---|---|
| | | | | PARTICLE | | EVALUATION OF TWO-COMPONENT DEVELOPER | | | | |
| | TONER | | | DIAMETER | | | | | ELECTROSTATIC | |
| | | CUTTING/ | | DISTRIBUTION | | | | | CHARGE (μC/g) | |
| | | PULVER- | | | VARIATION | | IMAGE | BACKGROUND | | AFTER |
| | | IZING | | D50 | COEFFICIENT | IMAGE | DENSITY | SOIL | AFTER 1 | 120 |
| | No. | EFFICIENCY | L/D | (μm) | (%) | DENSITY | IRREGULARITY | DENSITY | MINUTE | MINUTES |
| EXAMPLE 1 | A | ◯ | 0.30 | 6.53 | 15.4 | 1.34 | 4.9 | 0.002 | 18.7 | 19.1 |
| EXAMPLE 2 | B | ◯ | 0.27 | 6.47 | 14.6 | 1.33 | 4.7 | 0.002 | 17.8 | 18.3 |
| EXAMPLE 3 | C | ◯ | 0.24 | 6.58 | 16.5 | 1.34 | 5.1 | 0.001 | 19.2 | 19.0 |
| EXAMPLE 4 | D | ◯ | 0.41 | 6.77 | 17.1 | 1.39 | 5.6 | 0.002 | 18.1 | 18.0 |
| EXAMPLE 5 | E | ◯ | 0.49 | 6.44 | 15.6 | 1.38 | 5.0 | 0.001 | 17.7 | 17.5 |
| EXAMPLE 6 | F | ◯ | 0.28 | 6.62 | 15.7 | 1.35 | 4.9 | 0.000 | 18.2 | 18.2 |
| EXAMPLE 7 | G | ◯ | 0.88 | 6.51 | 15.3 | 1.40 | 4.4 | 0.005 | 15.2 | 14.4 |
| EXAMPLE 8 | H | ◯ | 0.21 | 6.45 | 18.9 | 1.33 | 5.6 | 0.001 | 19.7 | 20.5 |
| COMPARATIVE | I | ◯ | 1.43 | 6.49 | 15.5 | 1.45 | 4.2 | 0.011 | 13.4 | 9.7 |
| EXAMPLE 1 | | | | | | | | | | |
| COMPARATIVE | J | ◯ | — | 11.13 | 17.9 | 1.63 | 3.4 | 0.009 | 7.5 | 8.3 |
| EXAMPLE 2 | | | | | | | | | | |
| COMPARATIVE | K | ◯ | 1.27 | 5.71 | 16.2 | 1.16 | 7.6 | 0.004 | 22.6 | 24.1 |
| EXAMPLE 3 | | | | | | | | | | |
| COMPARATIVE | L | X | 2.34 | 4.98 | 23.4 | 1.32 | 12.8 | 0.013 | 26.4 | 18.6 |
| EXAMPLE 4 | | | | | | | | | | |
| COMPARATIVE | M | X | — | 6.45 | 22.6 | 1.36 | 8.9 | 0.001 | 19.4 | 19.5 |
| EXAMPLE 5 | | | | | | | | | | |

As obvious from Table 2, toners A to H having a ratio (L/D) of the cylindrical length (L) to the cylindrical cross-sectional diameter (D) of cylindrical toner particles at 0.1 to 0. 9 are more favorable in cutting/pulverizing efficiency than toners I, K, and L having a rate L/D of more than 0.9 and toners J and M that are not cylindrical. In addition, in Examples 1 to 8 in which the toners A to H were used, the image density, image density irregularity and background soil were favorable. The results seem to be associated with the reduction in anisotropy of the functional materials in toners A to H. In addition, the two-component developers of Examples 1 to 8 were resistant to fluctuation in electrostatic charge.

On the other hand, the toner I, which was produced by heat treatment at a temperature of 59.6° C., which is lower than the melting point of the binder resin, had a high ratio (L/D) of 1.43, because of the excessively low heat treatment temperature. It is probably because the cylindrical toner particles did not shrink sufficiently by heat, resulting in insufficient reduction of the anisotropy of the functional materials. The background soil density obtained in Comparative Example 1 by using the toner I was larger than that of Examples 1 to 8. Alternatively, the two-component developer of the Comparative Example 1 varied significantly in electrostatic charge and thus had unstable electrostatic properties.

The toner J, which was produced by heat treatment at a temperature lower by 9.6° C. than the melting point of the binder resin, resulted in fusion and aggregation of the toner because of excessively high heat treatment temperature, prohibiting calculation of the ratio (L/D). The background soil density obtained in Comparative Example 2 using the toner J was higher than that of Examples 1 to 8. It is probably because the reduction of the anisotropy of the functional materials was insufficient. Yet alternatively, the two-component developer of the Comparative Example 2 varied significantly in electrostatic charge and thus had unstable electrostatic properties.

The toners K and L, which were prepared by spinning at a spinning speed of less than 90 m/s, had a high ratio (L/D) of 1.0 or more. It is probably because the cylindrical toner particles could not make the most of orientation of the binder resin and did not shrink sufficiently by heat, resulting in insufficient reduction of the anisotropy of the functional materials. The image densities obtained in Comparative Example 3 and Comparative Example 4 using the toners K and L were lower than those of Examples 1 to 8. In addition, the values of the image density irregularity were also higher than those of Examples 1 to 8. In particular, Comparative Example 4 using the toner L, which was spun at a spinning speed of 67 m/s, was inferior in cutting/pulverizing efficiency and higher in background soil density.

The toner used in Comparative Example 5, which was prepared by pulverization method, was inferior in cutting/pulverizing efficiency and higher in image density irregularity than the toners in Examples.

An aspect of the present invention described above is a developer including a toner containing the cylindrical toner particles obtained by melting toner raw materials including binder resins, pigments, and waxes, forming a fibrous intermediate from the melted toner raw materials and cutting the fibrous intermediate, wherein the cylindrical toner particles have a ratio (L/D) of the cylindrical length (L) to the cylindrical cross-sectional diameter (D) of 0.1 to 0.9.

The invention in the configuration above provides a developer containing a toner superior in fixing efficiency and electrostatic properties. It is probably because it is possible to reduce generation of anisotropy of functional materials by spinning method. In addition, such a developer gives a high-quality image, when used in an image forming apparatus.

The cylindrical cross-sectional diameter (D) of the cylindrical toner particles is preferably 2 to 10 μm, and the cylindrical length (L) thereof is preferably 1 to 7 μm.

The cylindrical toner particles are preferably those obtained by addition of an external additive.

Another aspect of the present invention is an image forming apparatus, comprising an image carrier carrying an electrostatic latent image formed on the surface and a development roller placed at a position facing the image carrier that supports and conveys a developer toner on the surface and supplies the conveyed toner to the surface of the image carrier, wherein the developer including a toner containing the cylindrical toner particles obtained by melting toner raw materials including binder resins, pigments, and waxes, forming a fibrous intermediate from the melted toner raw materials and cutting the fibrous intermediate, wherein the cylindrical toner particles have a ratio (L/D) of the cylindrical length (L) to the cylindrical cross-sectional diameter (D) of 0.1 to 0.9. The apparatus according to the present invention in such a configuration, in which the developer toner used is superior in fixing efficiency and electrostatic properties, gives a high-quality image.

It is more preferably an image forming apparatus, comprising an image carrier for carrying an electrostatic latent image formed thereon, a magnetic roller conveying a two-component developer of toner and carrier, and a development roller placed at a position facing the image carrier and the magnetic roller, supporting and conveying the toner in the two-component developer on the surface in contact with the two-component developer conveyed by the magnetic roller and supplying the conveyed toner onto the surface of the image carrier. The image forming apparatus in such a configuration, in which the two-component developer toner used is superior in fixing efficiency and electrostatic properties, gives a high-quality image.

It is also preferably an image forming apparatus an image carrier carrying an electrostatic latent image formed on the surface and a development roller supporting and conveying a two-component developer of toner and carrier on the surface and supplying the toner in the conveyed two-component developer onto the surface of the image carrier, wherein the developer above is used as the two-component developer toner. The image forming apparatus in such a configuration, in which the developer toner used is superior in fixing efficiency and electrostatic properties, gives a high-quality image.

This application is based on Japanese Patent Application Serial No. 2008-014106 filed in Japan Patent Office on Jan. 24, 2008, the contents of which are hereby incorporated by reference.

Although the present invention has been fully described by way of example with reference to the accompanying drawing, it is to be understood that various changes and modifications will be apparent to those skilled in the art. Therefore, unless otherwise such changes and modifications depart from the scope of the present invention hereinafter defined, they should be construed as being included therein.

What is claimed is:

1. A developer, comprising a toner containing the cylindrical toner particles obtained by melting toner raw materials including binder resins, pigments, and waxes, forming a fibrous intermediate from the melted toner raw materials and cutting the fibrous intermediate, wherein
the cylindrical toner particles have a ratio (L/D) of the cylindrical length (L) to the cylindrical cross-sectional diameter (D) of 0.1 to 0.9.

2. The developer according to claim 1, wherein the cylindrical cross-sectional diameter (D) of the cylindrical toner particles is 2 to 10 μm.

3. The developer according to claim 1, wherein the cylindrical length (L) of the cylindrical toner particles is 1 to 7 μm.

4. The developer according to claim 1, wherein the toner is obtained by adding an external additive to the cylindrical toner particles.

5. An image forming apparatus, comprising
an image carrier carrying an electrostatic latent image formed on the surface and
a development roller placed at a position facing the image carrier that supports and conveys a developer toner on the surface and supplies the conveyed toner to the surface of the image carrier, wherein
the developer comprising a toner containing the cylindrical toner particles obtained by melting toner raw materials including binder resins, pigments, and waxes, forming a fibrous intermediate from the melted toner raw materials and cutting the fibrous intermediate, wherein the cylindrical toner particles have a ratio (L/D) of the cylindrical length (L) to the cylindrical cross-sectional diameter (D) of 0.1 to 0.9.
